(19) United States
(12) Patent Application Publication
(10) Pub. No.: US 2020/0036763 A1
(43) Pub. Date: Jan. 30, 2020

(54) INFORMATION PROCESSING APPARATUS AND CONTROL METHOD

(71) Applicant: CANON KABUSHIKI KAISHA, Tokyo (JP)

(72) Inventor: Wataru Honjo, Tokyo (JP)

(21) Appl. No.: 16/516,577

(22) Filed: Jul. 19, 2019

(30) Foreign Application Priority Data
Jul. 25, 2018 (JP) 2018-139623

(51) Int. Cl. H04L 29/06

(52) U.S. Cl. CPC H04L 65/4076; G08B 13/19656; H04L 65/60

(57) ABSTRACT

An information processing apparatus comprises a first network interface configured to function as an interface with a first network; a second network interface configured to function as an interface with a second network that is different from the first network; and a processing unit having a first mode in which multicast distribution of an image acquired by an image capturing unit is performed via one of the first network interface and the second network interface and multicast distribution is not performed via the other network interface, and a second mode in which multicast distribution is performed in a different form from the first mode, wherein the processing unit, upon the first network interface or the second network interface accepting a request for multicast distribution, selects one of the first mode and the second mode.

### BACKGROUND OF THE INVENTION

### Field of the Invention

The present invention relates to an information processing apparatus and a control method.

### Description of the Related Art

In surveillance camera systems, a technology that allows a camera to perform multicast distribution of video shot thereby in the case where a plurality of clients want to receive the video at the same time is commonly used (e.g., see Japanese Patent Laid-Open No. 2008-288875). For example, in the Open Network Video Interface Forum (hereinafter, ONVIF), which is a common standard concerning the connection between network cameras and clients, a StartMulticastStreaming command, which is a command for starting multicast distribution, has been standardized. In order to acquire authentication information regarding the connectivity of streaming as defined by ONVIF, it is deemed essential to employ multicast distribution and the StartMulticastStreaming command. Also, cameras may have a plurality of network interfaces (hereinafter, NWIFs). It is also possible, for example, for a camera to connect to a plurality of clients by both a wireless NWIF and a wired NWIF, and to perform multicast distribution using both NWIFs.

### SUMMARY OF THE INVENTION

However, the NWIF to perform multicast distribution is not designated in the request for starting multicast distribution, thus making it impossible to judge which NWIF to perform distribution from, in the case where the camera has a plurality of NWIFs.

Japanese Patent Laid-Open No. 2008-288875 discloses a method of filtering unnecessary multicast packets on the multicast receiving side. However, with the technology described in Japanese Patent Laid-Open No. 2008-288875, restrictions are not applied on the multicast distribution side, and thus the above problem cannot be solved. Also, shortages of network bandwidth can arise.

An aspect of the present invention provides a technology that is able to realize multicast distribution adapted to the circumstances, even in the case where an information processing apparatus such as a camera has a plurality of NWIFs.

An aspect of the present invention is provided with the following configuration.

An information processing apparatus comprises: a first network interface configured to function as an interface with a first network; a second network interface configured to function as an interface with a second network that is different from the first network; and a processing unit having a first mode in which multicast distribution of an image acquired by an image capturing unit is performed via one of the first network interface and the second network interface and multicast distribution is not performed via the other network interface, and a second mode in which multicast distribution is performed in a different form from the first mode, wherein the processing unit, upon the first network interface or the second network interface accepting a request for multicast distribution, selects one of the first mode and the second mode.

According to an aspect of the present invention, multicast distribution adapted to the circumstances can be realized, even in the case where an information processing apparatus such as a camera has a plurality of NWIFs.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a diagram showing a network configuration including a camera according to a first embodiment.

FIG. 2 is a block diagram showing the functions and configuration of the camera of FIG. 1.

FIGS. 3A and 3B are block diagrams respectively showing the functions and configuration of a wired client of FIG. 1 and a wireless client of FIG. 1.

FIG. 4 is a flowchart showing the flow of processing at the time of setting multicast distribution in the camera of FIG. 1.

FIG. 5 is a sequence diagram showing an example of the flow when the camera receives a request for multicast distribution via RTSP.

FIG. 6 is a sequence diagram showing an example of the flow when the camera receives a request for multicast distribution via ONVIF.

FIG. 7 is a flowchart showing the flow of processing at the time of setting multicast distribution in the camera according to a second embodiment.

FIG. 8 is a flowchart showing the flow of processing at the time of setting multicast distribution in the camera according to a third embodiment.

FIG. 9 is a block diagram showing the functions and configuration of the camera according to a fourth embodiment.

FIG. 10 is a flowchart showing the flow of processing at the time of stopping multicast distribution in the camera according to a fifth embodiment.

FIGS. 11A and 11B are diagrams illustrating operations at the time of restarting the camera according to a sixth embodiment.

FIG. 12 is a flowchart showing the flow of a series of processing in restarting of the camera of FIGS. 11A and 11B.

FIG. 13 is a diagram showing an example of the hardware configuration of the camera 10 of FIG. 1.

FIG. 14 is a diagram showing an example of the hardware configuration of the wired client of FIG. 1.

### DESCRIPTION OF THE EMBODIMENTS

Hereinafter, constituent elements, members and processing shown in the diagrams that are the same or equivalent will be given the same reference signs, and redundant description will be omitted as appropriate. Also, some members that are not relevant to the description have been omitted from the diagrams.

The following observations result from the inventor's own investigations.

With regard to the selection of a multicast distribution destination, current ONVIF standards do not clearly define a multicast distribution destination. When distribution is performed from all of a plurality of NWIFs in response to a request for multicast distribution, a shortage of network bandwidth can arise due to unnecessary multicast distribution being performed. Also, when the NWIF to perform multicast distribution is fixed in order to avoid this issue, difficulties can arise in performing multicast distribution to the network desired by a user.

In view of such problems, the following embodiments enable multicast distribution adapted to the circumstances of a client, by providing a camera with a function of designating an NWIF to perform multicast distribution, and determining an NWIF to be targeted for distribution according to the method of requesting multicast distribution and the circumstances.

### First Embodiment

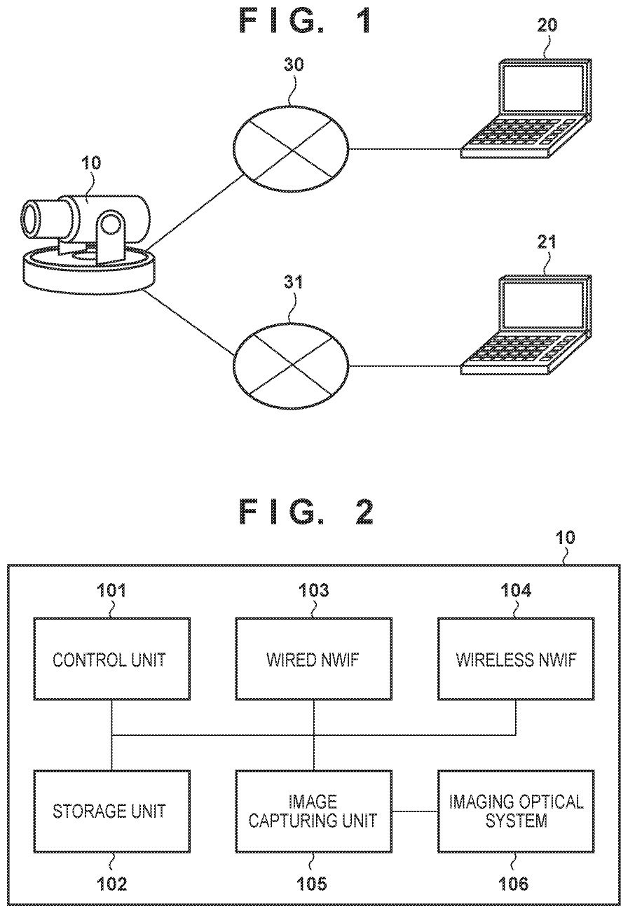

FIG. 1 is a diagram showing a network configuration including a camera 10 according to the first embodiment. The camera 10 has a wired NWIF capable of communication in a wired LAN and a wireless NWIF capable of communication in a wireless LAN. The camera 10 is connected to a wired network 30 through a wired LAN, and is connected in a communicable state to a wired client 20, which is an external apparatus, via the wired network 30. The camera 10 is connected to a wireless network 31 through a wireless LAN, and is connected in a communicable state to a wireless client 21, which is an external apparatus, via the wireless network 31. The camera 10 is a network camera, and selectively performs multicast distribution to the wired client 20 connected in a wired manner and the wireless client 21 connected in a wireless manner.

The wired network 30 and the wireless network 31 may each be constituted by a plurality of routers, switches, cables, access points and the like that meet communication standards such as Ethernet (registered trademark), Wi-Fi (registered trademark), and Bluetooth (registered trademark), for example. The wired NWIF and the wired network 30 are connected in a wired manner, such as by cable, for example. The wireless NWIF and the wireless network 31 are connected in a wireless manner, such as by short-range wireless communication, infrared communication or a mobile phone network, for example. Note that, in the present embodiment, as long as the camera 10 is able to communicate with the wired client 20 and the wireless client 21, any communication standard, size or configuration of the network may be adopted. The wired client 20 and the wireless client 21 transmit commands for performing processing such as PTZ (Pan-Tilt-Zoom) control and control of multicast distribution to the camera 10. The camera 10 transmits responses to commands to the wired client 20 and the wireless client 21.

Although an exemplary network configuration and exemplary communication are described above using FIG. 1, the network configuration shown in FIG. 1 illustrates one example, and the present invention is not limited thereto. Various modifications and changes can be made, such as a configuration in which the camera 10 is provided with three or more NWIFs and connects to three or more client apparatuses via different networks, and a configuration in which the camera 10 has only a plurality of wired NWIFs capable of communication in a wired LAN.

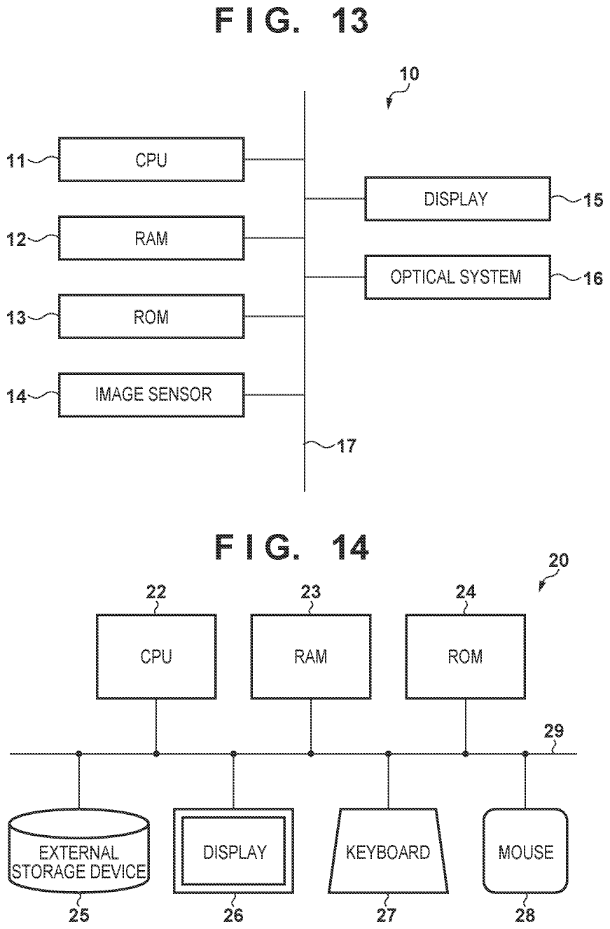

FIG. 13 is a diagram showing an example of the hardware configuration of the camera 10 of FIG. 1. The camera 10 is provided with a CPU 11, a RAM 12, a ROM 13, an image sensor 14 such as a CMOS sensor or a CCD sensor, a display 15, and an optical system 16. These members are connected to each other by a bus 17.

The CPU 11 performs overall controls of this apparatus in accordance with control programs that are stored in the RAM 12. The RAM 12 a memory for storing programs that are executed by the CPU 11 and data such as images, and is, for example, a volatile memory. The ROM 13 is a memory for saving data to be processed and programs for decompressing in the RAM 12, and is, for example, a nonvolatile memory.

The CPU 11 controls acquisition of images by the image sensor 14. The CPU 11 realizes desired enlargement/reduction and a desired field of view of images that are acquired with the image sensor 14, by controlling a motor or the like included in the optical system 16.

FIG. 14 is a diagram showing an example of the hardware configuration of the wired client 20 of FIG. 1. The wireless client 21 has a similar hardware configuration to the hardware configuration of the wired client 20 shown in FIG. 1. The wired client 20 is provided with a CPU 22, a RAM 23, a ROM 24, an external storage device 25 such as an HDD, a display 26, a keyboard 27, and a mouse 28. These members are connected to each other by a bus 29.

The CPU 22 performs overall control of the wired client 20 in accordance with control programs that are stored in the RAM 23. The RAM 23 is a memory for storing programs that are executed by the CPU 22 and data such as documents and images, and is, for example, a volatile memory. The ROM 24 is a flash memory or the like for saving data to be processed and programs for decompressing in the RAM 23, and is, for example, a nonvolatile memory. The display 26 displays images such as moving images acquired from the camera 10. The keyboard 27 functions as input means for the user to instruct and operate the wired client 20. The mouse 28 is a pointing device for the user to instruct and operate the wired client 20. The user is able to perform operations such as input and the like with respect to contents displayed on the display 26, using the keyboard 27 and the mouse 28.

FIG. 2 is a block diagram showing the functions and configuration of the camera 10 of FIG. 1. Although the blocks shown in FIG. 2 and subsequent block diagrams can be realized in a hardware manner with elements and mechanical apparatuses including the CPU of a computer, and can be realized in a software manner with computer programs and the like, functional blocks that are realized through cooperation between hardware and software are depicted here. Accordingly, a person skilled in the art who comes across this specification would understand that these functional blocks can be realized in various forms through a combination of hardware and software.

The camera 10 is provided with a control unit 101, a storage unit 102, a wired NWIF 103, a wireless NWIF 104, an image capturing unit 105, and an imaging optical system 106. The control unit 101 performs overall control of the camera 10, which is an information processing apparatus. The control unit 101 is constituted by processing means such as a CPU, for example. The storage unit 102 is used as a storage area for programs that are mainly executed by the control unit 101, a work area during program execution, a storage area for setting values of network connection settings and the like, a storage area for information concerning the wired client 20 and wireless client 21 that are connected, and a storage area for various data such as an area for storing or temporarily saving image data that is generated by the image capturing unit 105 described later.

The wired NWIF 103 functions as an interface with the wired network 30. The wired NWIF 103 includes, for example, a circuit that performs modulation/demodulation of signals that are transmitted by wired LAN, and an interface circuit for sending signals to a wired line (e.g., Ethernet cable) or receiving signals from a wired line. The wired NWIF 103 receives commands for changing setting values and commands for control from the wired client 20 via the wired network 30. Also, the wired NWIF 103 transmits responses to commands and various data such as image data stored in the storage unit 102 to the wired client 20 via the wired network 30. The wired NWIF 103, in the case where a command is acquired from the wired client 20, generates a command reception event, and transmits or notifies the generated command reception event to the control unit 101. The control unit 101 receives the command reception event transmitted from the wired NWIF 103.

The wireless NWIF 104 functions as an interface with the wireless network 31. The wireless NWIF 104 includes, for example, a circuit that performs processing in baseband, and a circuit that converts baseband signals into radio frequency signals and sends the resultant signals via an antenna or receives radio frequency signals via the antenna and converts the received signals into baseband signals. The wireless NWIF 104 receives commands for changing setting values and commands for control from the wireless client 21 via the wireless network 31. Also, the wireless NWIF 104 transmits responses to commands and various data such as image data stored in the storage unit 102 to the wireless client 21 via the wireless network 31. The wireless NWIF 104, in the case where a command is acquired from the wireless client 21, generates a command reception event, and transmits or notifies the generated command reception event to the control unit 101. The control unit 101 receives the command reception event transmitted from the wireless NWIF 104.

The image capturing unit 105 converts analog signals acquired by capturing images of objects formed by the imaging optical system 106 of the camera 10 into digital data, and outputs the resultant digital data to the storage unit 102 as captured images. When a captured image is output to the storage unit 102, the control unit 101 receives an image acquisition event from the image capturing unit 105.

Although functions and a configuration of the camera 10 are described above using FIG. 2, the processing blocks shown in FIG. 2 are examples, and the present invention is not limited thereto. Various modifications and changes can be made, such as providing a video analysis unit, an audio input unit, and an audio output unit in the camera 10.

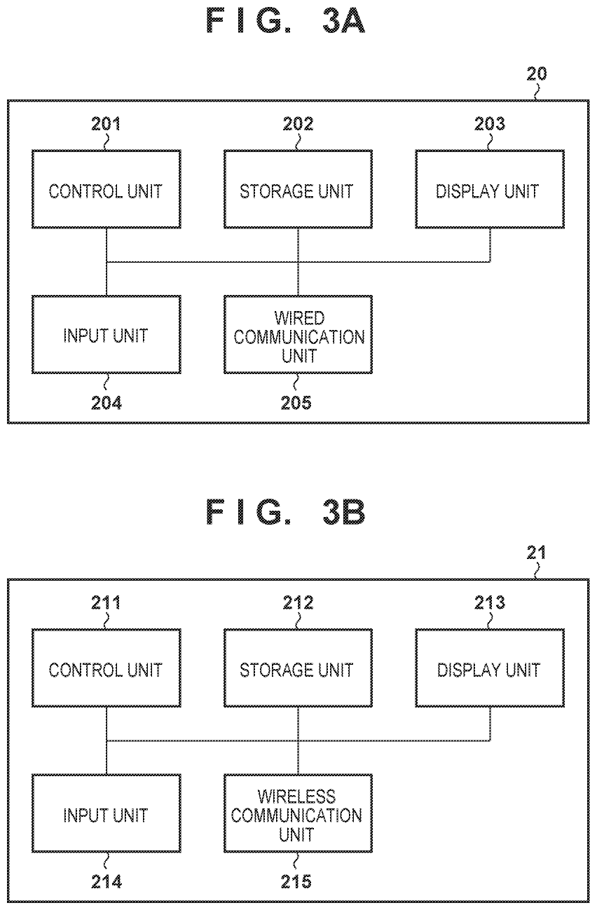

FIGS. 3A and 3B are block diagrams respectively showing the functions and configuration of the wired client 20 of FIG. 1 and the wireless client 21 of FIG. 1. Referring to FIG. 3A, the wired client 20 is provided with a control unit 201, a storage unit 202, a display unit 203, an input unit 204, and a wired communication unit 205. The control unit 201 is constituted by a CPU, for example, and performs overall control of the wired client 20.

The storage unit 202 is used as a storage area for programs that are mainly executed by the control unit 201, a work area during program execution, and a storage area for various data such as information on connectable cameras that currently exist on the wired network 30.

The display unit 203 is constituted by an LCD, an organic electroluminescence display or the like, for example, and displays various setting screens, data acquisition/display screens, a viewer for video that is received from the camera 10, various messages and the like to the user of the wired client 20.

The input unit 204 is constituted by buttons, a D-pad, a touch panel, a mouse or the like, for example, and notifies the contents of screen operations by the user to the control unit 201.

The wired communication unit 205 includes, for example, a circuit that performs modulation/demodulation of signals that are transmitted by wired LAN, and an interface circuit for sending signals to a wired line or receiving signals from a wired line. The wired communication unit 205 transmits commands for making various changes including changing network settings to the camera 10 via the wired network 30. Also, the wired communication unit 205 receives responses to commands for making changes and video streams from the camera 10 via the wired network 30.

Referring to FIG. 3B, the wireless client 21 is provided with a control unit 211, a storage unit 212, a display unit 213, an input unit 214, and a wireless communication unit 215. The control unit 211, the storage unit 212, the display unit 213 and the input unit 214 have functions and configurations that are respectively equivalent to the control unit 201, the storage unit 202, the display unit 203 and the input unit 204 of the wired client 20 (FIG. 3A), and thus description thereof will be omitted.

The wireless communication unit 215 includes, for example, a circuit that performs processing in baseband, and a circuit that converts baseband signals into radio frequency signals and sends the resultant signals via an antenna, or receives radio frequency signals via the antenna and converts the received signals into baseband signals. The wireless communication unit 215 transmits commands for making various changes including changing network settings to the camera 10 via the wireless network 31. Also, the wireless communication unit 215 receives responses to the commands for making changes and video streams from the camera 10 via the wireless network 31.

Although configurations of the wired client 20 and the wireless client 21 are described above using FIG. 3A and FIG. 3B, the processing blocks shown in FIG. 3A and FIG. 3B are examples, and the present invention is not limited thereto. An image analysis processing unit and a video storage unit may be provided in a client, or both a wired communication unit and a wireless communication unit may be provided in a client. In this way, various modifications and changes can be made.

Operations of the camera 10 constituted as described above will be described.

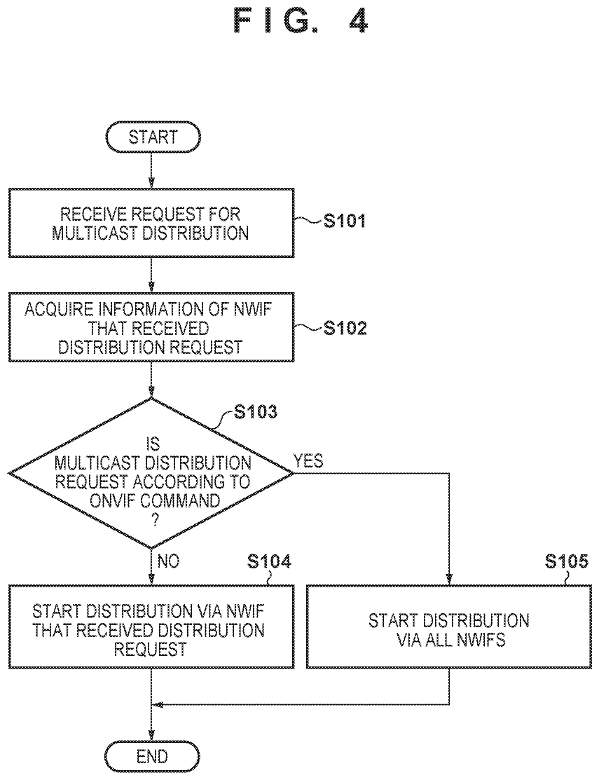

FIG. 4 is a flowchart showing the flow of processing at the time of setting multicast distribution in the camera 10 of FIG. 1. In step S101, the camera 10 receives a request for multicast distribution from the wired client 20 or the wireless client 21. In the case where the wired client 20 generates and transmits the request for multicast distribution, the wired NWIF 103 accepts the request. In the case where the wireless client 21 generates and transmits the request for multicast distribution, the wireless NWIF 104 accepts the request. An RTSP (Real Time Streaming Protocol) request and an ONVIF request are given as specific examples of requests for multicast distribution that are sent by the wired client 20 and the wireless client 21.

In step S102, the control unit 101 of the camera 10 acquires NWIF information relating to the NWIF that received the request for multicast distribution in step S101. The NWIF information includes information specifying the NWIF that received the request for multicast distribution in step S101. This information indicates, for example, which of the wired NWIF 103 and the wireless NWIF 104 accepted the request for multicast distribution. The method of determining the NWIF that received the request for multicast distribution may, for example, be a method that involves storing IP addresses respectively specifying the wired NWIF 103 and the wireless NWIF 104 in the storage unit 102 of the camera 10, and determining the NWIF by the IP address included as an address in the received request for distribution, or may be another method.

In step S103, the control unit 101 of the camera 10 selects one of an all distribution mode and an individual distribution mode, according to the type of request for multicast distribution received in step S101. The form of multicast distribution, in particular, the NWIF via which multicast distribution is to be performed, differs between the all distribution mode and the individual distribution mode. The control unit 101, in the case where the request for multicast distribution received in step S101 is a RTSP request (NO in step S103), selects the individual distribution mode, by advancing the processing to step S104. In step S104 (individual distribution mode), the control unit 101 starts multicast distribution of an image acquired with the image capturing unit 105 and read out from the storage unit 102, via the NWIF specified in step S102 (i.e., NWIF that received the request for multicast distribution). At this time, the control unit 101 does not perform multicast distribution via the other NWIF, that is, the NWIF that did not receive the request for multicast distribution. Specifically, the control unit 101 establishes only a session that uses the NWIF specified in step S102, and starts multicast distribution.

The control unit 101, in the case where the request for multicast distribution received in step S101 is an ONVIF request (YES in step S103), selects the all distribution mode, by advancing the processing to step S105. In step S105 (all distribution mode), the control unit 101 starts multicast distribution via both the wired NWIF 103 and the wireless NWIF 104 (i.e., all of the NWIFs), regardless of which NWIF received the request for multicast distribution.

Although processing when starting multicast distribution according to the present embodiment is described above with reference to FIG. 4, the flowchart shown in FIG. 4 is an example, and the present invention is not limited thereto. For example, processing may be changed depending on which of a TEARDOWN method of RTSP request and a StopMulticastStreaming command as defined by ONVIF is received, not only when requesting starting of multicast distribution but also when requesting stopping of multicast distribution (described later in fifth embodiment). Various modifications and changes can be made in the case of responding to a plurality of types of stop requests, such as further providing the camera 10 with stop request means and means for determining the NWIF for stopping multicast distribution depending on the NWIF that received the stop request.

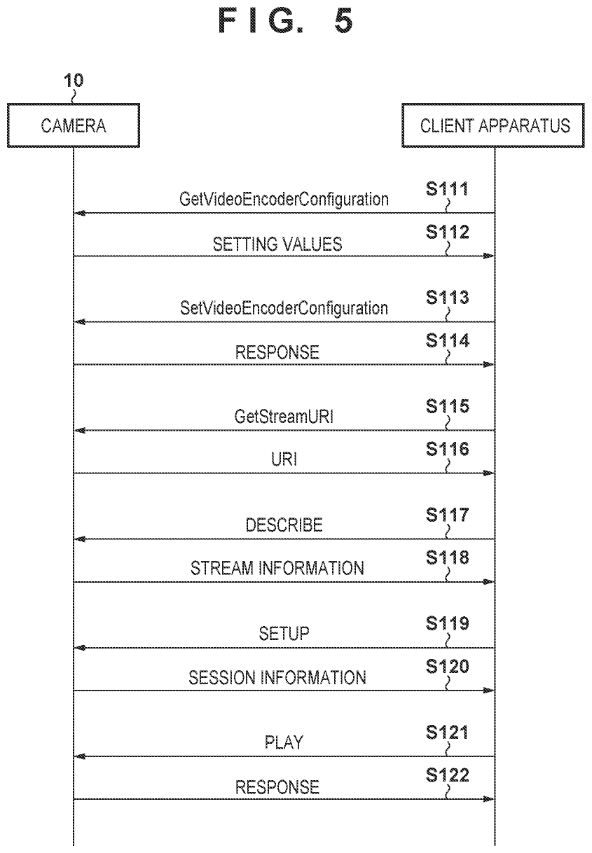

FIG. 5 is a sequence diagram showing an example of the flow when the camera 10 receives a request for multicast distribution via RTSP. In step S111, the client apparatus, which is the wired client 20 or the wireless client 21, transmits a GetVideoEncoderConfiguration command as defined by ONVIF to the camera 10. This command is a command for acquiring the current values of VideoEncoderConfiguration including setting values relating to video that is distributed by the camera 10. The parameters of VideoEncoderConfiguration include setting values relating to multicasting. The camera 10, upon receiving the GetVideoEncoderConfiguration command, transmits the current values of VideoEncoderConfiguration to the client apparatus, according to the request, in step S112.

In step S113, the client apparatus transmits a SetVideoEncoderConfiguration command as defined by ONVIF to the camera 10. This command is a command for requesting changing of VideoEncoderConfiguration including setting values relating to video that is distributed by the camera 10. In the case of needing to change the setting values relating to multicasting acquired in step S112, the client apparatus transmits the SetVideoEncoderConfiguration command to the camera 10. The camera 10, upon receiving the SetVideoEncoderConfiguration command, updates the setting values according to the request, and transmits a response to the client apparatus in step S114.

In step S115, the client apparatus transmits a GetStreamURI command as defined by ONVIF to the camera 10. This command is a command for requesting the camera 10 for an URI to be used when the client apparatus sends a RTSP request. The camera 10, upon receiving the GetStreamURI command, transmits the URI to the client apparatus in step S116.

In step S117, the client apparatus transmits a RTSP request using a DESCRIBE method to the camera 10. The DESCRIBE method is a method for acquiring information relating to video that is distributed by the camera 10. The client apparatus transmits the URI acquired in step S116 to the camera 10 together with the RTSP request. The camera 10, upon receiving the RTSP request, transmits information on the stream to be distributed to the client apparatus, according to the sent URI, in step S118.

In step S119, the client apparatus transmits a RTSP request using a SETUP method to the camera 10. The SETUP method is a method for requesting establishment of an RTP session for performing distribution. The client apparatus transmits the URI assigned to the information on the stream with respect to which it is desired to establish a session to the camera 10 together with the RTSP request, based on the information on the stream acquired in step S118. The camera 19, upon receiving the RTSP request, establishes a session for performing multicast distribution, and, in step S120, transmits information on the established session to the client apparatus.

In step S121, the client apparatus transmits a RTSP request using a PLAY method to the camera 10. The PLAY method is a method for requesting the camera 10 to start video distribution. The client apparatus transmits information on the session acquired in step S120 to the camera 10 together with the RTSP request. The camera 10, upon receiving the RTSP request, starts multicast distribution, according to the received information on the session, and, in step S122, transmits a successful response to the client apparatus if multicast distribution can be started and transmits an error response if multicast distribution cannot be started.

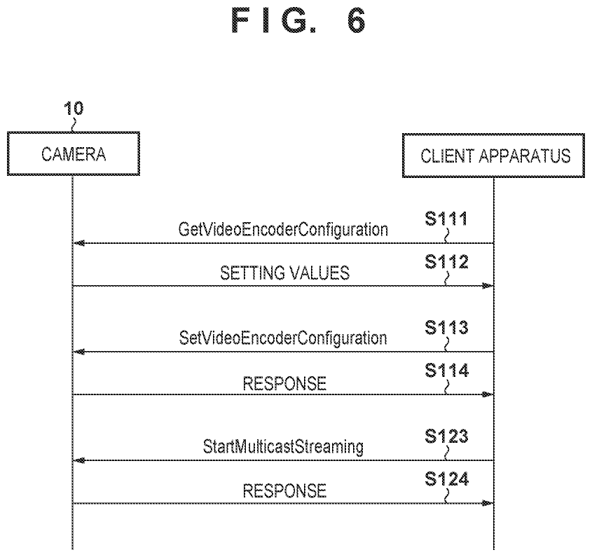

FIG. 6 is a sequence diagram showing an example of the flow when the camera 10 receives a request for multicast distribution via ONVIF. Note that since transmission of the GetVideoEncoderConfiguration command (step S111), reception of setting values (step S112), transmission of the SetVideoEncoderConfiguration command (step S113) and reception of a response (step S114) are similar to that in the sequence diagram of FIG. 5, description thereof will be omitted.

In step S123, the client apparatus transmits the StartMulticastStreaming command as defined by ONVIF to the camera 10. This command is a command for the client apparatus to request the camera 10 to start multicast distribution. The camera 10, in the case where the StartMulticastStreaming command is received, establishes a session for performing multicast distribution in accordance with the setting values of VideoEncoderConfiguration that are set in the camera 10, and starts multicast distribution using the established session. In step S124, the camera 10 transmits a successful response to the client apparatus if multicast distribution can be started, and transmits an error response if multicast distribution cannot be started.

Although a method of requesting multicast distribution is described above using FIG. 5 and FIG. 6, the sequence diagrams of FIG. 5 and FIG. 6 are examples, and the present invention is not limited thereto.

The camera 10 according to the present embodiment is configured to be capable of responding to a plurality of types of start requests for multicast distribution. The camera 10, when a start request for multicast distribution is received, determines the NWIF for applying multicast distribution, based on the NWIF that received the request for multicast distribution and the type of request. It is thereby possible to determine an NWIF to serve as the distribution source even in the case where there are a plurality of NWIFs, and to realize multicast distribution adapted to the circumstances of the client.

Also, the camera 10 according to the present embodiment is able to select an NWIF to be used in multicast distribution, depending on how multicast distribution is requested. Accordingly, the flexibility with which multicast distribution can be set is enhanced.

### Second Embodiment

The first embodiment described the case where one of the all distribution mode and the individual distribution mode is selected according to the type of request for multicast distribution. In the second embodiment, one of the all distribution mode and the individual distribution mode is selected, according to the connection state with an external apparatus via the wired NWIF 103 or the wireless NWIF 104. The network configuration concerning the camera according to the second embodiment is similar to the network configuration shown in FIG. 1. The functions and configuration of the camera according to the second embodiment are similar to the functions and configuration of the camera 10 shown in FIG. 2. The respective functions and configuration of the wired client and the wireless client that communicate with the camera according to the second embodiment are similar to the functions and configuration of the wired client 20 and the wireless client 21 shown in FIGS. 3A and 3B.

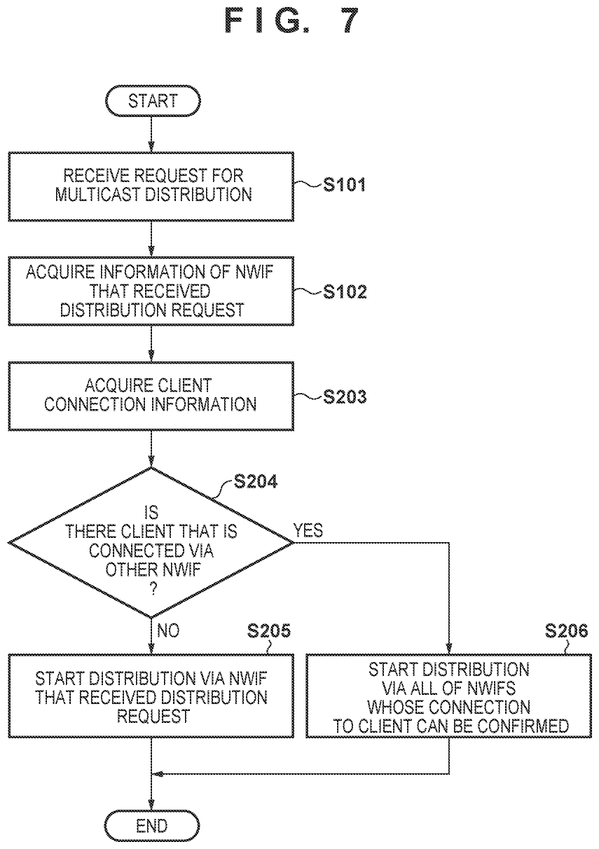

FIG. 7 is a flowchart showing the flow of processing at the time of setting multicast distribution in the camera according to the second embodiment. Since reception of a request for multicast distribution (step S101) and acquisition of information on the NWIF that received the distribution request (step S102) are similar to that in the flowchart of FIG. 4, description thereof will be omitted.

In step S203, the camera acquires client connection information, which is information concerning the connection between the camera and a client. The camera acquires, for each client that has established a connection with the camera, information specifying the NWIF being used in the connection. The method for acquiring information specifying the NWIF being used in the connection with a client may, for example, be a method that involves determining the NWIF by the IP address included as an address in the connection request that the camera receives from the client, or may be another method.

In step S204, the camera determines whether there is a client that is connected using the other NWIF, not the NWIF that received the request for multicast distribution. The camera performs this determination, based on the information, acquired in step S102, specifying the NWIF that accepted the request for distribution and the information, acquired in step S203, specifying the NWIF that is being used in the connection. The camera, in the case where the other NWIF is also connected to a client (YES in step S204), selects the all distribution mode, by advancing the processing to step S206. In step S206 (all distribution mode), the camera starts multicast distribution via all of the NWIFs that are connected to a client, regardless of which NWIF received the request for multicast distribution.

The camera, in the case where there is not an NWIF being used in the connection with a client apart from the NWIF that received the request for multicast distribution (NO in step S204), selects the individual distribution mode, by advancing the processing to step S205. In step S205 (individual distribution mode), the camera starts multicast distribution of an image acquired with the image capturing unit 105 and read out from the storage unit 102, via the NWIF specified in step S102 (i.e., NWIF that received the request for multicast distribution). At this time, the camera does not perform multicast distribution via the NWIF that did not receive the request for multicast distribution. Specifically, the camera establishes only a session that uses the NWIF specified in step S102, and starts multicast distribution.

Although processing at the time of starting multicast distribution according to the present embodiment is described above with reference to FIG. 7, the flowchart shown in FIG. 7 is one example, and the present invention is not limited thereto. For example, the camera may be further provided with means for determining whether to distribute the image to all of the NWIFs whose connection to a client can be confirmed, according to the type of request for multicast distribution received. Also, the camera may be provided with means for detecting establishment of a connection with a client. In this case, the camera may be further provided with means for, in the case where establishment of a connection with a client that uses another NWIF is detected after the start of multicast distribution, starting multicast distribution that uses the NWIF whose connection is detected. In this way, various modifications and changes can be made.

The camera according to the present embodiment is configured to be capable of responding to a plurality of types of start requests for multicast distribution. The camera, when a start request for multicast distribution is received, determines the NWIF for applying multicast distribution, on the basis of the NWIF that received the request for multicast distribution and the NWIF that is used in the connection with the client. It is thereby possible to determine an NWIF to serve as the distribution source even in the case where there are a plurality of NWIFs, and to realize multicast distribution adapted to the circumstances of the client. A difference from the first embodiment is that the connection state with the client is used when determining the NWIF to serve as the source of multicast distribution.

### Third Embodiment

The first embodiment described the case where one of the all distribution mode and the individual distribution mode is selected according to the type of request for multicast distribution. In the third embodiment, one of the individual distribution mode and the all distribution mode is selected, according to information indicating which of the wired NWIF 103 and the wireless NWIF 104 accepted the request for multicast distribution. The network configuration concerning the camera according to the third embodiment is similar to the network configuration shown in FIG. 1. The functions and configuration of the camera according to the third embodiment are similar to the functions and configuration of the camera 10 shown in FIG. 2. The respective functions and configuration of the wired client and the wireless client that communicate with the camera according to the third embodiment are similar to the functions and configuration of the wired client 20 and the wireless client 21 shown in FIGS. 3A and 3B.

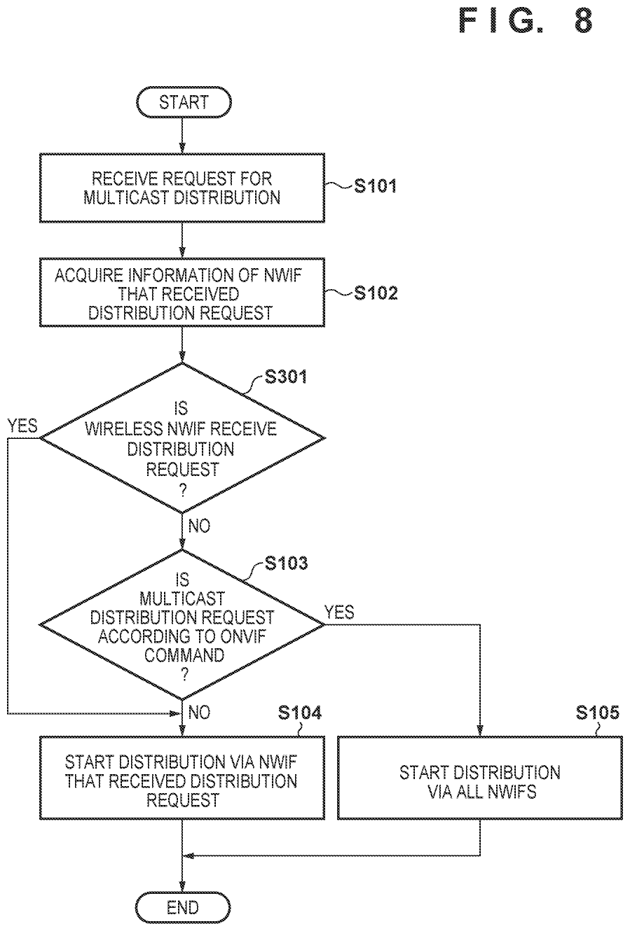

FIG. 8 is a flowchart showing the flow of processing at the time of setting multicast distribution in the camera according to the third embodiment. Since reception of a request for multicast distribution (step S101), acquisition of information on the NWIF that received the distribution request (step S102), selection in a mode depending on the type of request (step S103), the individual distribution mode (step S104) and the all distribution mode (step S105) are similar to that in the flowchart of FIG. 4, description thereof will be omitted.

In step S301, the camera determines whether the NWIF specified in step S102 (i.e., NWIF that received the request for multicast distribution) is the wireless NWIF 104. The camera, in the case where it is determined that the specified NWIF is the wireless NWIF 104 (YES in step S301), skips the determination of step S103, and selects the individual distribution mode by advancing the processing to step S104. The camera, in the case where it is determined that the specified NWIF is the wired NWIF 103 (NO in step S301), advances the processing to step S103.

With the camera according to the present embodiment, similar operation and effect are achieved to the operation and effect achieved by the camera 10 according to the first embodiment. In addition, in the present embodiment, the all distribution mode is prohibited in the case where the wireless NWIF 104 receives a request for multicast distribution. Accordingly, security for a client connected to the camera wirelessly can be enhanced, for example.

Although the present embodiment describes the case where the all distribution mode is prohibited if the wireless NWIF 104 receives a request for multicast distribution, the present invention is not limited thereto. For example, selection of the all distribution mode may be prohibited in the case where the wired NWIF 103 receives a request for multicast distribution.

### Fourth Embodiment

The first embodiment described the case where the camera 10 is provided with the wired NWIF 103 and the wireless NWIF 104, and the control unit 101 selects one of the individual distribution mode and the all distribution mode, according to which of the wired NWIF 103 and the wireless NWIF 104 accepted the request for multicast distribution. In the fourth embodiment, a camera 510 is provided with two different wireless NWIFs, that is, a first wireless NWIF 503 and a second wireless NWIF 504.

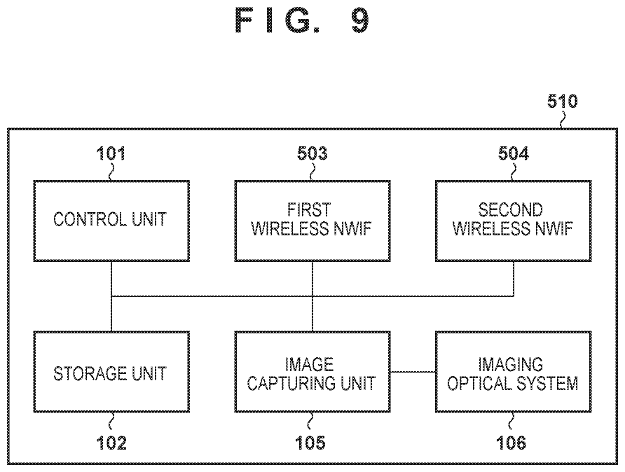

FIG. 9 is a block diagram showing the functions and configuration of the camera 510 according to the fourth embodiment. The camera 510 is provided with the control unit 101, the first wireless NWIF 503, the second wireless NWIF 504, the storage unit 102, the image capturing unit 105, and the imaging optical system 106.

The first wireless NWIF 503 and the second wireless NWIF 504 respectively include circuits for processing signals that conform to different wireless communication standards. For example, the first wireless NWIF 503 includes a circuit for processing signals that conform to Bluetooth (registered trademark) Low Energy, and the second wireless NWIF 504 includes a circuit for processing Wi-Fi signals. Alternatively, the first wireless NWIF 503 includes a circuit for processing signals for short-range wireless communication, and the second wireless NWIF 504 includes a circuit for processing signals that conform to mobile phone communication standards such as 3G, 4G and 5G. The first wireless NWIF 503 and the second wireless NWIF 504 may respectively be dedicated integrated circuits for processing signals that conform to supported wireless communication standards.

The control unit 101 may, similarly to the first and second embodiments, realize the individual distribution mode via the wireless NWIF that received the request for multicast distribution, out of the first wireless NWIF 503 and the second wireless NWIF 504. Alternatively, the control unit 101 may, similarly to the third embodiment, select one of the individual distribution mode and the all distribution mode, according to information indicating which of the first wireless NWIF 503 and the second wireless NWIF 504 accepted the request for multicast distribution.

With the camera according to the present embodiment, similar operation and effect are achieved to the operation and effect achieved by the cameras according to the first, second and third embodiments.

Although the present embodiment describes the case where there are a plurality of wireless NWIFs, the present invention is not limited thereto, and a plurality of wired NWIFs may be provided in correspondence with a plurality of types of wired communication standards, for example. Alternatively, the technical idea according to the present embodiment is also applicable in the case where the camera has a plurality of wireless NWIFs and a plurality of wired NWIFs.

### Fifth Embodiment

The first embodiment described operations when setting multicast distribution. The fifth embodiment describes operations when stopping multicast distribution that is already being performed. The camera according to the fifth embodiment, upon the wired NWIF 103 or the wireless NWIF 104 accepting a request for stopping multicast distribution, when multicast distribution via both the wired NWIF 103 and the wireless NWIF 104 is being performed, selects to stop multicast distribution performed via one of the wired NWIF 103 and the wireless NWIF 104 and not stop multicast distribution performed via the other NWIF, or to stop both multicast distribution performed via the wired NWIF 103 and multicast distribution performed via the wireless NWIF 104.

The network configuration concerning the camera according to the fifth embodiment is similar to the network configuration shown in FIG. 1. The functions and configuration of the camera according to the fifth embodiment are similar to the functions and configuration of the camera 10 shown in FIG. 2. The respective functions and configuration of the wired client and the wireless client that communicate with the camera according to the fifth embodiment are similar to the functions and configuration of the wired client 20 and the wireless client 21 shown in FIGS. 3A and 3B.

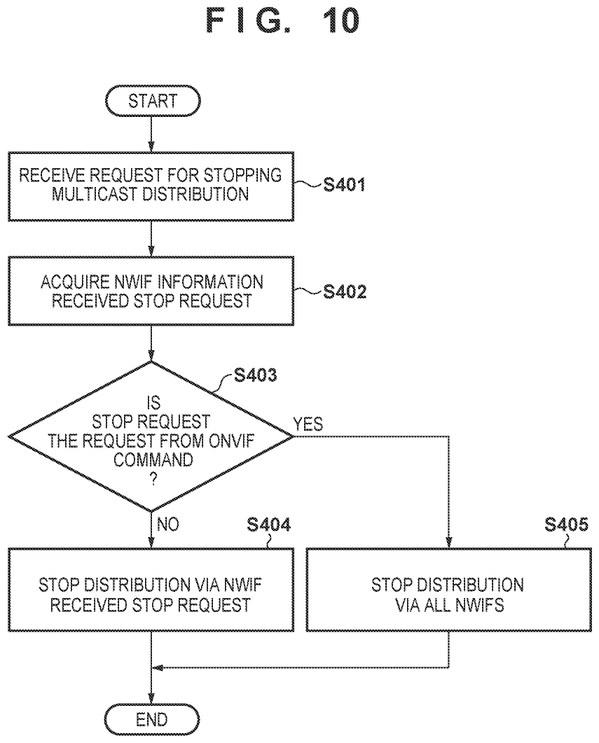

FIG. 10 is a flowchart showing the flow of processing at the time of stopping of multicast distribution in the camera according to the fifth embodiment. At the start time of the flow, the camera is assumed to be performing multicast distribution via both the wired NWIF 103 and the wireless NWIF 104. In step S401, the camera receives a request for stopping multicast distribution from the wired client 20 or the wireless client 21. In the case where the wired client 20 generates and transmits the request for stopping multicast distribution, the wired NWIF 103 accepts the request. In the case where the wireless client 21 generates and transmits the request for stopping multicast distribution, the wireless NWIF 104 accepts the request.

In step S402, the control unit 101 of the camera acquires NWIF information relating to the NWIF that received the request for stopping multicast distribution in step S401. The NWIF information includes information specifying the NWIF that received the request for stopping multicast distribution in step S401. This information shows, for example, which of the wired NWIF 103 and the wireless NWIF 104 accepted the request for stopping multicast distribution. The method of determining the NWIF that received the request for stopping multicast distribution may, for example, be a method that involves storing IP addresses respectively specifying the wired NWIF 103 and the wireless NWIF 104 in the storage unit 102 of the camera 10, and determining the NWIF by the IP address included as an address in the received request for stopping distribution, or may be another method.

In step S403, the control unit 101 of the camera selects one of an all stop mode and an individual stop mode, according to the type of request for stopping multicast distribution received in step S401. The form of stopping multicast distribution, in particular, the NWIF via which multicast distribution is to be stopped, differs between the all stop mode and the individual stop mode. The control unit 101, in the case where the request for stopping multicast distribution received in step S401 is a RTSP request (NO in step S403), selects the individual stop mode, by advancing the processing to step S404. Such a RTSP request is a RTSP request using the TEARDOWN method, for example. In step S404 (individual stop mode), the control unit 101 stops the multicast distribution performed via the NWIF specified in step S402 (i.e., NWIF that received the request for stopping multicast distribution). However, the control unit 101 continues the multicast distribution performed via the other NWIF, that is, the NWIF that did not receive the request for stopping multicast distribution.

The control unit 101, in the case where the request for multicast distribution received in step S401 is an ONVIF request (YES in step S403), selects the all stop mode, by advancing the processing to step S405. Such an ONVIF request is a StopMulticastStreaming command, for example. In step S405 (all stop mode), the control unit 101 stops the multicast distribution performed via both the wired NWIF 103 and the wireless NWIF 104 (i.e., all of the NWIFs), regardless of which NWIF received the request for stopping multicast distribution.

With the camera according to the present embodiment, similar operation and effect are achieved to the operation and effect achieved by the cameras according to the first, second and third embodiments. Additionally, even in the case where there are a plurality of NWIFs performing multicast distribution, it is possible to determine the NWIF for stopping distribution, and to realize stopping of multicast distribution adapted to the circumstances of the client.

### Sixth Embodiment

The first embodiment described operations when setting multicast distribution. The sixth embodiment describes operations when restarting the camera. The camera according to the sixth embodiment, at the time of resuming multicast distribution (ONVIF AutoStart function) after restarting the camera, determines the NWIF to serve as the distribution destination at the time of resumption, on the basis of the previous distribution destination and the current configuration of the communication means.

The network configuration concerning the camera according to the sixth embodiment is similar to the network configuration shown in FIG. 1. The functions and configuration of the camera according to the sixth embodiment are similar to the functions and configuration of the camera 10 shown in FIG. 2.

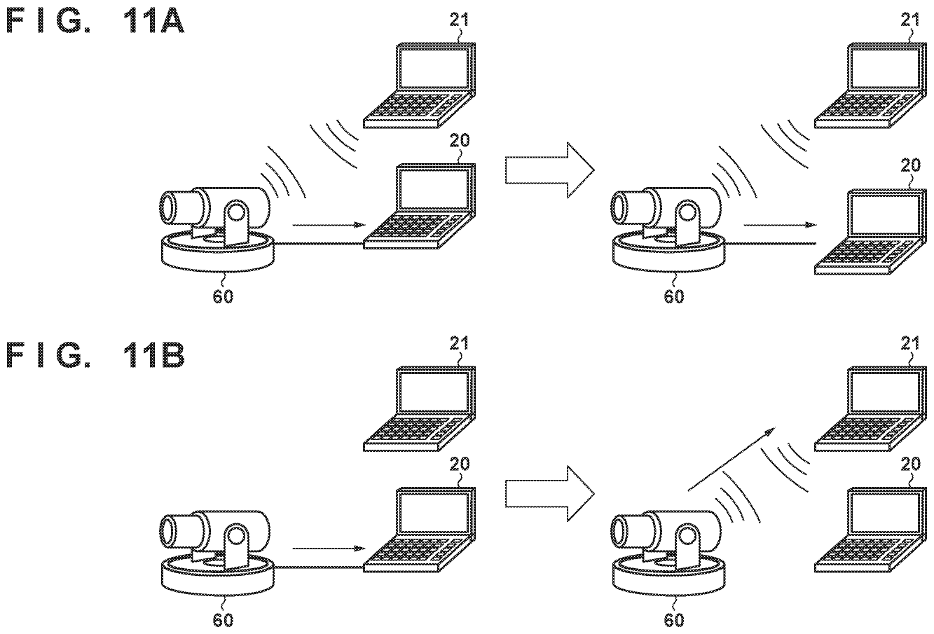

FIGS. 11A and 11B are diagrams illustrating operations at the time of restarting a camera 60 according to the sixth embodiment. FIG. 11A corresponds to the case where the connection relationship does not change before and after restart. Before restart (left side of FIG. 11A), the camera 60 respectively establishes a connection with the wired client 20 via the wired NWIF 103 and with the wireless client 21 via the wireless NWIF 104. The camera 60, in the individual distribution mode, performs multicast distribution only to the wired client 20. The camera 60 is shutdown in this state. Thereafter, upon the camera 60 being restarted (right side of FIG. 11A), the camera 60 determines that the connection state with the client is equivalent to before restart, and sets multicast distribution in the same manner as before restart. That is, the camera 60 selects the individual distribution mode, the same as before restart, and performs multicast distribution only to the wired client 20.

FIG. 11B corresponds to the case where connection relationship changes before and after restart. Before restart (left side of FIG. 11B), the camera 60 has established a connection with the wired client 20 via the wired NWIF 103, but is not connected to the wireless client 21. The camera 60, in the individual distribution mode, performs multicast distribution only to the wired client 20. The camera 60 is shutdown in this state. During shutdown, the cable for wired connection is removed from the camera 60, and the wireless connection function of the wireless client 21 is turned on. Thereafter, upon the camera 60 being restarted (right side of FIG. 11B), the camera 60 determines that the connection state with the client has changed from before restart. That is, the camera 60 determines that the wired NWIF 103 has been disabled and the wireless NWIF 104 has been enabled. In accordance with the determination that a restart following a change in the enabled/disabled states of the NWIFs was performed, the camera 60 switches the multicast distribution destination according to the connection state of the NWIFs. In the example of FIG. 11B, the camera 60 stops the multicast distribution performed via the wired NWIF 103 that has been disabled, and instead starts multicast distribution via the wireless NWIF 104 that has been enabled.

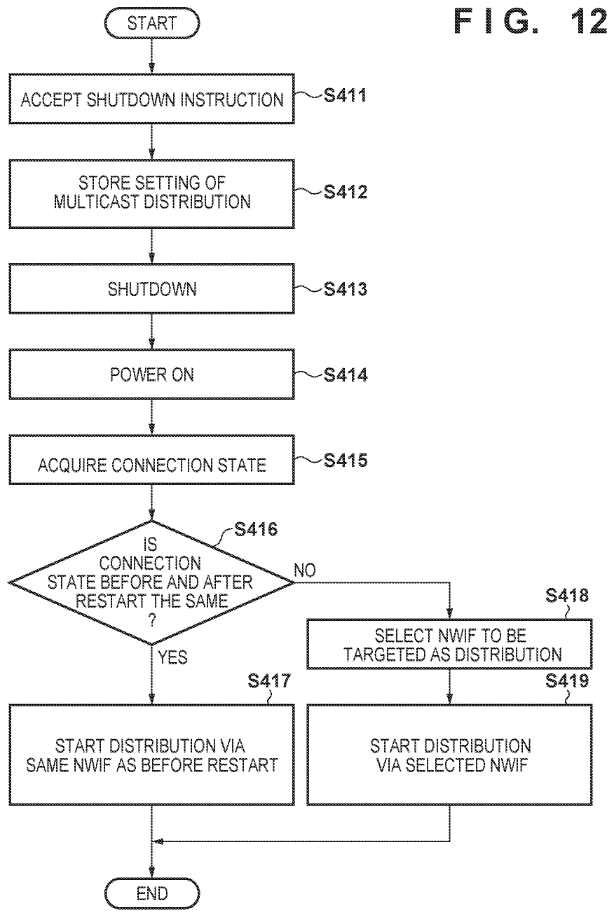

FIG. 12 is a flowchart showing the flow of a series of processing in restarting of the camera 60 of FIGS. 11A and 11B. In step S411, the camera 60 accepts a shutdown instruction from the user. For example, the camera 60, upon detecting that a power button (not shown) has been depressed, accepts the depressing of the power button as a shutdown instruction. Alternatively, the camera 60 may accept a shutdown instruction via the wired network 30 or the wireless network 31.

In step S412, the camera 60 stores the settings of the multicast distribution that is being performed at that time in the storage unit 102. The information that is stored includes, for example, the connection state at that time, the mode of multicast distribution, and the NWIF that is selected as the target for multicast distribution. The connection state includes, for example, information indicating, for each NWIF, whether a connection is established with an external client via that NWIF. In the example of FIG. 11A, the information stored in step S412 includes information indicating, with regard to the wired NWIF 103, that a connection has been established with the wired client 20, and information indicating, with regard to the wireless NWIF 104, that a connection has been established with the wireless client 21. Also, the information stored in step S412 includes information indicating that the individual distribution mode has been selected, and information indicating that multicast distribution is being performed via the wired NWIF 103 and multicast distribution is not being performed via the wireless NWIF 104. In an example of FIG. 11B, the information stored in step S412 includes information indicating, regarding the wired NWIF 103, that a connection has been established with the wired client 20, and information indicating, regarding the wireless NWIF 104, that no connection has been established. Also, the information stored in step S412 includes information indicating that the individual distribution mode has been selected, and information indicating that multicast distribution is being performed via the wired NWIF 103 and multicast distribution is not being performed via the wireless NWIF 104.

In step S413, the camera 60 shuts down. In step S414, the camera 60 is powered on. The camera 60 is powered on upon the power button of the camera 60 being depressed. Alternatively, power-on of the camera 60 may be controlled via the wired network 30 or the wireless network 31.

In step S415, the camera 60 acquires the connection state at that time. The camera 60, as part of initialization processing at the time of restart, attempts to connect to an external client via the wired NWIF 103 and the wireless NWIF 104. The camera 60 determines whether connection via the wired NWIF 103 was established and whether connection via the wireless NWIF 104 was established by this attempt.

In step S416, the camera 60 determines whether the connection state before and after restart is the same, by referring to the connection state before restart stored in the storage unit 102 in step S412, and comparing that connection state with the connection state after restart acquired in step S415. If determined to be the same (YES in step S416), the camera 60, in step S417, starts multicast distribution via the same NWIF as the NWIF targeted for distribution before restart stored in the storage unit 102 in step S412. For example, in the case where multicast distribution was being performed in the all distribution mode before restart, the camera 60 also selects the all distribution mode after restart, and starts multicast distribution performed via both the wired NWIF 103 and the wireless NWIF 104. Alternatively, as shown in FIG. 11A, in the case where the individual distribution mode was selected before restart, the camera 60 also selects the individual distribution mode after restart, the same as before restart, and starts multicast distribution via only the same NWIF as before restart.

If it is determined that the connection state differs before and after restart (NO in step S416), the camera 60, in step S418, selects an NWIF to be targeted for multicast distribution. For example, the camera 60 may select an NWIF to be targeted for multicast distribution from among the NWIFs that have established a connection with an external client at that time. In an example of FIG. 11B, because the connection state differs before and after restart, the camera 60 selects the wireless NWIF 104, which has established a connection with the wireless client 21 after restart, as the NWIF to be targeted for multicast distribution. Alternatively, in the case where only the connection via the wired NWIF 103 existed before restart and the connections via the wired NWIF 103 and the wireless NWIF 104 are established after restart, the camera 60 may select the all distribution mode, and select both the wired NWIF 103 and the wireless NWIF 104 as distribution targets.

In step S419, the camera 60 starts multicast distribution via the NWIF selected in step S418.

With the camera 60 according to the present embodiment, similar operation and effect are achieved to the operation and effect achieved by the cameras according to the first, second and third embodiments. Additionally, the camera 60 according to the present embodiment, at the time of restarting the camera 60, selects one of the individual distribution mode and the all distribution mode, with reference to the setting of multicast distribution before restart. Accordingly, setting of multicast distribution at the time of restart adapted to the circumstances of the client can be realized.

Also, with the camera 60 according to the present embodiment, one of the individual distribution mode and the all distribution mode is selected based on a comparison of the connection state with an external client via the wired NWIF 103 or the wireless NWIF 104 at the time of restart and the setting of multicast distribution before restart. Accordingly, for example, if there is no change in the connection state, the setting of multicast distribution is not changed before and after restart, and, if there is a change, multicast distribution can be appropriately reconfigured in accordance with the contents of the change.

The configurations and operations of cameras according to the embodiments are described above. These embodiments are illustrative, and a person skilled in the art would understand that various modifications can be made through combinations of the respective constituent elements and processing thereof, and that such modifications are also within the scope of the present invention.

Although the first, third and fourth embodiments described the case where the all distribution mode is selected in the case where the request results from an ONVIF command, and the individual distribution mode is selected in the case where the request results from a RTSP request, the present invention is not limited thereto. For example, conversely, the individual distribution mode may be selected in the case where the request results from an ONVIF command, and the all distribution mode may be selected in the case where the request results from a RTSP request. Also, although the fifth embodiment described the case where the all stop mode is selected in the case where the request results from an ONVIF command, and the individual stop mode is selected in the case where the request results from a RTSP request, the present invention is not limited thereto. For example, conversely, the individual stop mode may be selected in the case where the request results from an ONVIF command, and the all stop mode may be selected in the case where the request results from a RTSP request.

Although the first, second, third, fourth and sixth embodiments described the case where the NWIF for applying multicast distribution is selected on the camera side, without designation of the NWIF being carried out on the client side, the present invention is not limited thereto, and the NWIF for use in multicast distribution may be designated when this distribution is requested on the client side. In this case, for example, information (IP address of NWIF, etc.) specifying the NWIF selected on the client side may be added to any of the RTSP requests shown in FIG. 5. Alternatively, information specifying the NWIF selected on the client side may be added to the StartMulticastStreaming command shown in FIG. 6. The camera may extract the information specifying the NWIF from the received RTSP request or StartMulticastStreaming command. The camera may also set the extracted NWIF as the NWIF for applying multicast distribution.

The information specifying the NWIF selected on the client side may be 1-bit data, with “0” representing that all of the NWIFs are distribution sources, and “1” representing that only the NWIF that is being used in communication with the client serving as the request source is the distribution source. Alternatively, the information specifying the NWIF selected on the client side may be 2-bit data, with “00” representing that both the wired NWIF 103 and the wireless NWIF 104 are selected, “01” representing that only the wired NWIF 103 is selected, and “10” representing that only the wireless NWIF 104 is selected.

Also, although the fifth embodiment described the case where the NWIF for stopping multicast distribution is selected on the camera side, without designation of the NWIF for stopping multicast distribution being carried out on the client side, the present invention is not limited thereto. For example, the NWIF to be targeted for stopping may be designated when stopping of multicast distribution is requested on the client side.

Although the first, second, third, fourth and sixth embodiments described the case where, in the individual distribution mode, multicast distribution is executed via only the NWIF that accepted the request for multicast distribution, the present invention is not limited thereto. For example, in the individual distribution mode, multicast distribution may be executed via only the NWIF that did not accept the request for multicast distribution. Also, although the fifth embodiment described the case where, in the individual stop mode, multicast distribution via the NWIF that accepted the request for stopping multicast distribution is stopped, the present invention is not limited thereto. For example, in the individual stop mode, multicast distribution via the NWIF that did not accept the request for stopping multicast distribution may be stopped.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-139623, filed Jul. 25, 2018, which is hereby incorporated by reference herein in its entirety.

What is claimed is:

1. An information processing apparatus comprising:
a first network interface configured to function as an interface with a first network;
a second network interface configured to function as an interface with a second network that is different from the first network; and
a processing unit having a first mode in which multicast distribution of an image acquired by an image capturing unit is performed via one of the first network interface and the second network interface and multicast distribution is not performed via the other network interface, and a second mode in which multicast distribution is performed in a different form from the first mode,
wherein the processing unit, upon the first network interface or the second network interface accepting a request for multicast distribution, selects one of the first mode and the second mode.

2. The information processing apparatus according to claim 1,
wherein the processing unit, in the second mode, performs multicast distribution of the image acquired by the image capturing unit via both the first network interface and the second network interface.

3. The information processing apparatus according to claim 1,
wherein one of a connection between the first network interface and the first network and a connection between the second network interface and the second network is a wired connection, and the other connection is a wireless connection.

4. The information processing apparatus according to claim 1,
wherein the processing unit, upon the first network interface or the second network interface accepting a request for stopping multicast distribution, when multicast distribution via both the first network interface and the second network interface is being performed, selects to stop multicast distribution performed via one of the first network interface and the second network interface and not stop multicast distribution performed via the other network interface, or to stop both multicast distribution performed via the first network interface and multicast distribution performed via the second network interface.

5. The information processing apparatus according to claim 1,
wherein the processing unit selects one of the first mode and the second mode, according to which of the first network interface and the second network interface accepted the request for multicast distribution.

6. The information processing apparatus according to claim 1,
wherein the processing unit selects one of the first mode and the second mode, according to a type of the accepted request for multicast distribution.

7. The information processing apparatus according to claim 1,
wherein the processing unit selects one of the first mode and the second mode, according to a connection state with an external apparatus via the first network interface or the second network interface.

8. The information processing apparatus according to claim 1,
wherein the processing unit, at a time of restarting the information processing apparatus, selects one of the first mode and the second mode, with reference to setting of multicast distribution before restart.

9. The information processing apparatus according to claim 8,
wherein the processing unit selects one of the first mode and the second mode based on a comparison of a connection state with an external apparatus via the first network interface or the second network interface at the time of restart and the setting of multicast distribution before restart.

10. An information processing apparatus comprising:
a first network interface configured to function as an interface with a first network;
a second network interface configured to function as an interface with a second network that is different from the first network; and
a processing unit configured to, upon the first network interface or the second network interface accepting a request for stopping multicast distribution, when multicast distribution via both the first network interface and the second network interface is being performed, select to stop multicast distribution performed via one of the first network interface and the second network interface and not stop multicast distribution performed via the other network interface, or to stop both multicast distribution performed via the first network interface and multicast distribution performed via the second network interface.

11. A control method of an information processing apparatus including a first network interface configured to function as an interface with a first network and a second network interface configured to function as an interface with a second network that is different from the first network, the method comprising:
in a first mode, performing multicast distribution of an image acquired by an image capturing unit via one of the first network interface and the second network interface and not performing multicast distribution via the other network interface;
in a second mode, performing multicast distribution in a different form from the first mode; and
upon the first network interface or the second network interface accepting a request for multicast distribution, selecting one of the first mode and the second mode.

12. A control method of an information processing apparatus including a first network interface configured to function as an interface with a first network and a second network interface configured to function as an interface with a second network that is different from the first network, the method comprising:
in a first mode, performing multicast distribution of an image acquired by an image capturing unit via one of the first network interface and the second network interface and not performing multicast distribution via the other network interface; and
upon the first network interface or the second network interface accepting a request for stopping multicast distribution, when multicast distribution via both the first network interface and the second network interface is being performed, selecting to stop multicast distribution performed via one of the first network interface and the second network interface and not stop multicast distribution performed via the other network interface, or to stop both multicast distribution performed via the first network interface and multicast distribution performed via the second network interface.

13. A non-transitory computer-readable storage medium storing a computer program for causing a computer to execute a control method of an information processing apparatus including a first network interface configured to function as an interface with a first network and a second network interface configured to function as an interface with a second network that is different from the first network, the method comprising:
in a first mode, performing multicast distribution of an image acquired by an image capturing unit via one of the first network interface and the second network interface and not performing multicast distribution via the other network interface;
in a second mode, performing multicast distribution in a different form from the first mode; and
upon the first network interface or the second network interface accepting a request for multicast distribution, selecting one of the first mode and the second mode.
